(19) United States
(12) Patent Application Publication
(10) Pub. No.: US 2025/0235830 A1
(43) Pub. Date: Jul. 24, 2025

(54) CELLULOSE ULTRAFILTRATION MEMBRANE AND PREPARATION METHOD THEREOF

(71) Applicant: Hangzhou Cobetter Filtration Equipment Co., Ltd., Hangzhou (CN)

(72) Inventor: Jiandong Jia, Hangzhou (CN)

(21) Appl. No.: 19/172,692

(22) Filed: Apr. 8, 2025

Related U.S. Application Data
(63) Continuation of application No. PCT/CN2023/110344, filed on Jul. 31, 2023.

(30) Foreign Application Priority Data
Oct. 27, 2022 (CN) 202211329602.2

(51) Int. Cl. B01D 71/10; B01D 61/14; B01D 67/00; B01D 69/02; B01D 69/12; B01D 71/36

(52) U.S. Cl. CPC B01D 71/10; B01D 61/145; B01D 67/00165; B01D 69/02; B01D 69/1216; B01D 69/125; B01D 71/36; B01D 2325/02834; B01D 2325/04; B01D 2325/20

(57) ABSTRACT

The present disclosure discloses a cellulose ultrafiltration membrane and a preparation method thereof, belonging to the technical field of membrane materials. The cellulose ultrafiltration membrane comprises a main body, the main body successively being an ultrafiltration layer, a support layer and a base layer in a fluid flow direction; the ultrafiltration layer and the support layer each comprise a cellulose polymer layer, the base layer comprises a polytetrafluoroethylene layer, and a PMI average pore size of the base layer is >1 μm; the polytetrafluoroethylene layer is a hydrophilic polytetrafluoroethylene layer; the cellulose polymer layer and the polytetrafluoroethylene layer permeate and bind to form a binding layer; a scanning electron microscope (SEM) average pore size of a first side surface is 1-90 nm; the polytetrafluoroethylene layer is relatively flat in surface and strong in solvent resistance, the cellulose polymer layer in the prepared ultrafiltration membrane is relatively small in defect.

### CROSS-REFERENCE TO RELATED APPLICATIONS

This application is a continuation of International Application No. PCT/CN2023/110344, filed on Jul. 31, 2023, which claims priority to Chinese Patent Application No. 202211329602.2, filed on Oct. 27, 2022. All of the aforementioned applications are incorporated herein by reference in their entireties.

### TECHNICAL FIELD

The present disclosure relates to the technical field of membrane materials, more particularly to a cellulose ultrafiltration membrane and a preparation method thereof.

### BACKGROUND

A membrane technology is a new technology for efficient separation in contemporary times. Compared with the traditional technologies such as distillation and rectification, the membrane technology has the advantages of high separation efficiency, low energy consumption, small occupied area and the like. The core of the membrane separation technology is a separation membrane, wherein a polymer filter membrane is a class of separation membranes prepared by using organic high polymers as raw materials according to a certain process; according to different types of high polymers, the polymer filter membrane is subdivided into a cellulose polymer filter membrane, a polyamide polymer filter membrane, a sulfone polymer filter membrane, a polytetrafluoroethylene polymer filter membrane and the like; in addition, the polymer filter membrane is also divided into a microfiltration membrane, an ultrafiltration membrane, a nanofiltration membrane and a reverse osmosis membrane according to the pore size of the membrane.

The ultrafiltration membrane is a polymer semipermeable membrane that is capable of separating polymer colloids or suspended particles with certain sizes from a solution during the ultrafiltration. The ultrafiltration membrane is widely used for deep treatment of industrial wastewater and process water, such as concentration, purification and separation of macromolecular substances in chemical industry, food and medical industry, sterilization of biological solutions, separation of dyes from printing and dyeing wastewater, recovery of glycerol from petrochemical wastewater, recovery of silver from photographic chemical wastewater, and preparation of ultrapure water. In addition, the ultrafiltration membrane is also used for concentration and dewatering of sludge, and the like.

In polymer ultrafiltration membranes made of different materials, the cellulose polymer ultrafiltration membrane has relatively low non-specific adsorptivity in concentration, purification and separation of a protein due to its relatively high hydrophily, thereby preventing the adsorption of protein molecules, which, on the one hand, prevents a decrease in protein yield, and on the other hand, avoids the too rapid blockage of the utrafiltration membrane.

However, since the strength of the cellulose polymer ultrafiltration membrane is relatively low, composite cellulose ultrafiltration membranes with base material layers are emerged on the market, endowing the entire membrane with relatively high mechanical strength and increasing practical applicability. In general, the composite ultrafiltration membranes on the market adopt non-woven fabrics as base layers, i.e., a cellulose polymer was coated onto the surface of the non-woven fabric to form the composite ultrafiltration membrane, the preparation process is relatively simple. However, the surface of the non-woven fabric is relatively rough, when the cellulose is coated onto the base material layer of the non-woven fabric, fiber protrusion portions on the surface and end portions with warped fibers are extremely prone to puncturing the cellulose ultrafiltration layer in the ultrafiltration membrane, leading to the damaged surface of the ultrafiltration membrane and then seriously affecting the integrity of the membrane.

A microporous membrane has a relatively flat surface. The composite ultrafiltration membrane prepared by using the microporous membrane as the base layer has good integrity, for example, Xiamen University's public patent CN103877867B discloses a cellulose ultrafiltration membrane which comprises a microfiltration membrane and a cellulose skin layer and adopts a 0.2 μm polytetrafluoroethylene microfiltration membrane as a support layer. However, the preparation process of the cellulose ultrafiltration membrane is that a cellulose membrane preparing liquid is filtered onto the microporous membrane to form a nanoporous cellulose skin layer via free accumulation, and therefore the cellulose membrane preparing liquid does not permeate into the polytetrafluoroethylene microfiltration membrane. Meanwhile, the pore size of the used polytetrafluoroethylene microfiltration membrane is too small (0.2 μm), so it is easy to generate a phenomenon that solutes are rapidly aggregated and accumulated at an interface of the microfiltration membrane. Although the polytetrafluoroethylene microfiltration membrane has a relatively good interception rate, it leads to the relatively low flux of the entire membrane so that the filtration time is too long during the practical use, thereby reducing the efficiency.

### SUMMARY

The objective of the present disclosure is to provide a cellulose ultrafiltration membrane and a preparation method thereof. The ultrafiltration membrane uses a microporous membrane containing a polytetrafluoroethylene layer as a base layer and a cellulose polymer as an ultrafiltation layer, and has a molecular weight cut off of 1-750 K. Meanwhile, the ultrafiltration membrane is few in defects, high in integrity, uniform in ultrafiltration layer surface pores, rapid in flow rate, high in flux and short in filtration time.

In order to achieve the above objective, the present disclosure adopts the following technical solution:

Provided is a cellulose ultrafiltration membrane, comprising a main body, wherein the main body comprises:
a first side surface supplying a filtration liquid to be filtered, and
a second side surface discharging a permeate liquor through the main body;
the main body being successively an ultrafiltration layer, a support layer and a base layer in a fluid flow direction;
the ultrafiltration layer and the support layer comprising cellulose polymer layers, and the base layer comprising a polytetrafluoroethylene layer,
the PMI average pore size of the base layer being >0.8 μm;
the polytetrafluoroethylene layer being a hydrophilic polytetrafluoroethylene layer;
the cellulose polymer layer and the polytetrafluoroethylene layer permeating and binding to form a binding layer;
the scanning electron microscope (SEM) average pore size of a first side surface being 1-90 nm.

In the present disclosure, the cellulose ultrafiltration membrane is a composite membrane and consists of the cellulose polymer layer and the polytetrafluoroethylene layer. Compared with an ultrafiltration membrane having an integrated structure, the composite ultrafiltration membrane optimizes the function of each layer, so that the performance of the entire membrane is more ideal.

In the present disclosure, the main body of the cellulose ultrafiltration membrane is successively an ultrafiltration layer, a support layer and a base layer in a fluid flow direction, wherein, the ultrafiltration layer mainly takes an effect of intercepting substances. One side of the ultrafiltration layer is a first side surface supplying a liquid to be filtered, on which there are pores having relatively small pore sizes and taking a good interception effect. As well known, the pore size is a key factor for intercepting substances, and different pore sizes intercept substances with different particle sizes; studies have found that when the SEM average pore size of the first side surface is 1-90 nm, such the pore sizes are suitable for intercepting various biological molecule substances (such as an antibody or other substances) with molecular weight cut off of 1 K-750 K and facilitate the acquisition of relatively high interception efficiency, and meanwhile the concentration and purification of various biological protein products in a form of tangential flow erode and sweep away particles intercepted on the surface of the membrane so as to prevent the surface of the membrane from being blocked; the existence of the support layer takes an protective effect on the ultrafiltration layer to prevent fiber structures such as burrs on the binding layer from affecting or even destroying the membrane pore structure of the ultrafiltration layer, and then affecting the overall interception efficiency of the membrane, thereby further ensuring that the ultrafiltration layer efficiently intercepts corresponding substances.

In the present disclosure, both the ultrafiltration layer and a transition layer are prepared by phase conversion of the cellulose polymer, and are cellulose polymer layers. Therefore, the ultrafiltration layer has extremely strong hydrophily and difficultly adsorbs biological molecules such as the antibody, thereby ensuring relatively high product yield; furthermore, there is only one membrane-forming polymer (i.e., cellulose polymer) but no other membrane-forming polymers in the ultrafiltration layer and the support layer, of course, it is not excluded that there are very small amount of solvents, pore-forming agents and the like.

In the present disclosure, the microporous membrane comprising the polytetrafluoroethylene layer as the base layer. First, polytetrafluoroethylene has good pollution resistance and chemical reagent resistance, during the preparation, the present disclosure adopts a preparation method that after dissolution, a membrane-casting solution is subjected to casting and phase separation, some organic reagents (such as acetone and dioxane) that similarly have relatively strong solubility on the base material layer are used when the membrane-casting solution is prepared, and therefore when the base layer is poor in chemical reagent resistance, the solvent in the membrane-casting solution easily has a certain dissolution effect on the base layer as well so that the surface of the originally relatively flat base layer has many potholes and the surface becomes uneven, leading to a fact that the finally prepared cellulose ultrafiltration membrane has many surface defects and relatively poor integrity. The base layer comprises the polytetrafluoroethylene layer, and the surface of the polytetrafluoroethylene layer contacts and binds with the cellulose polymer layer, this is because the surface of the polytetrafluoroethylene layer is relatively flat and good solvent resistance prevents the surface from being partially dissolved to form the potholes, thus the cellulose polymer layer in the prepared ultrafiltration membrane has relatively small defects, and the ultrafiltration membrane has relatively good integrity; furthermore, the base layer takes the effect of supporting the cellulose polymer layer so as to ensure that the entire membrane has good mechanical strength and relatively high pressure resistance, and is suitable for long-time stable filtration under the action of a relatively high pressure; and meanwhile, the base layer adopts the microporous membrane, which ensures that the entire membrane has relatively high flux and relatively rapid flow rate, with a rapid filtration speed.

But at the same time, it is found that when the cellulose polymer membrane-casting solution is coated onto the surface of the polytetrafluoroethylene layer for phase conversion, a phenomenon that solutes are rapidly aggregated and accumulated occurs at the interface of the polytetrafluoroethylene layer, so as to easily cause a phenomenon of a great decrease in flow, however, in the present disclosure, it is defined that the PMI average pore size of the adopted base layer is >0.8 μm and meanwhile the polytetrafluoroethylene layer is a hydrophilic polytetrafluoroethylene layer, on this basis, the cellulose polymer permeates into the polytetrafluoroethylene layer during the preparation to form a binding layer, so as to eliminate the phenomenon of solute accumulation so that the prepared ultrafiltration membrane has good flux and meanwhile the binding layer also endows better composite performance between the cellulose polymer layer and the polytetrafluoroethylene layer, i.e., the peeling strength between the polytetrafluoroethylene layer is improved to prevent a phenomenon of peeling occurring during the use or between the cellulose polymer layer and the polytetrafluoroethylene layer.

In the present disclosure, if the PMI average pore size of the base layer is too small, or the polytetrafluoroethylene layer is too hydrophobic, it is easy to create a situation that the cellulose polymer cannot permeate into the polytetrafluoroethylene layer to form the binding layer, so as not to eliminate the phenomenon of solute accumulation to cause a decrease in flux; meanwhile, it is surprisingly found by the inventor that the use of a large-pore-size and hydrophilic polytetrafluoroethylene layer as the base material layer makes the pores on the surface of the ultrafiltration layer more uniform so that the filtration performance of the ultrafiltration membrane is more stable and uniform; this may be because the solid content or viscosity of the cellulose polymer membrane-casting solution is impossibly maintained to be uniform and stable due to large-batch production during the practical production, leading to a fact that the pore size of the surface of the finally prepared ultrafiltration layer is also relatively non-uniform; when a small-pore-size and hydrophobic polytetrafluoroethylene layer is used as the base, a small-pore-size and hydrophobic polytetrafluoroethylene layer coagulating bath slowly permeates in the process of preparation and phase separation, the phase separation starts from the upper surface of the cellulose polymer membrane-casting solution during the phase separation (when being immersed into the coagulating bath, contact first occurs at this place), and phase separation is gradually carried out toward the inside, and after the ultrafiltration layer is formed, the immersion into the coagulating bath is slow due to small surface pore size of the ultrafiltration layer, the cellulose polymer membrane-casting solution of the polytetrafluoroethlene layer basically completes phase separation when in contact with the cellulose polymer membrane-casting solution permeating into the polytetrafluoroethylene layer, however, the use of a macroporous and hydrophilic polytetrafluoroethylene layer in the present disclosure makes the coagulating bath more easily enter from the polytetrafluoroethylene layer side, so as to more rapidly contact with the cellulose polymer membrane-casting solution permeating into the polytetrafluoroethylene layer for phase separation. Therefore, at this moment, the cellulose polymer in the membrane-casting solution outside the interface of the polytetrafluoroethylene layer is grabbed. Furthermore, since the solid content or viscosity of the cellulose polymer membrane-casting solution is instable, the occurrence of grabbing allows the solid content and viscosity of the membrane-casting solution outside the interface of the polytetrafluoroethylene layer to become more uniform and stable, thereby making pores on the surface become more uniform. At the same time, the grabbing of solutes in the membrane-casting solution outside the interface of the polytetrafluoroethylene layer also relieves the phenomenon of solute accumulation. Furthermore, since the solute outside the interface of the polytetrafluoroethylene layer is reduced, the support layer becomes relatively thin, thereby improving the flux.

A method for measuring the SEM average pore size of the first side surface is to perform morphology characterization on a membrane structure by using a scanning electron microscope followed by performing measurement using computer software (such as Matlab and NIS-Elements) or in a manual manner and performing corresponding calculation; in the preparation process of the membrane, various characteristics of the membrane such as pore size distribution are roughly uniform and basically consistent in a direction vertical to the thickness of the membrane (if the membrane is in a flat membrane form, this direction is a plane direction; if the membrane is in a hollow fiber membrane form, this direction is a direction vertical to a radius); therefore, the overall average pore size of this plane is reflected by the average pore size of partial regions of a corresponding plane. During the practical measurement, the surface of the membrane is characterized by using an electron microscope to obtain a corresponding SEM image. Since the pores on the surface of the membrane are roughly uniform, a certain area such as 1 μm² (1 μm multiplied by 1 μm) or 25 μm² (5 μm multiplied by 5 μm) is selected, a specific area size depends on actual situations and then the pore sizes of all pores on this area are measured by corresponding software or in a manual manner, and then the average pore size of this surface is obtained by calculation; the pore area rate of the internal surface is a ratio of a sum of all pores on this surface to the area of this surface; of course, those skilled in the art also obtain the above parameters through other measurement means, and the above measurement means are only for reference.

In the present disclosure, a PMI pore size is obtained by testing via a Porous Materials Inc pore size tester. The PMI pore size of the base layer is obtained by directly measuring the base layer, or by dissolving a cellulose ultrafiltration membrane with a solvent (for example, N-methylmorpholine N-oxide (NMMO), an ionic liquid and an alkali/urea system), or by enzymolysis of a cellulose to obtain the base layer and then testing via the PMI pore size tester.

Further, the discrete coefficient of the SEM average pore size of the first side surface is less than 0.5.

In the present disclosure, the SEM average pore size of the first side surface is relatively uniform, with a discrete coefficient of less than 0.5, so that during the use, ultrafiltration layers in different regions have relatively uniform molecular weight cut off to prevent the deviation in the same membrane or between membranes at the same batch, leading to non-uniform filtration performance.

Further, the base layer comprises a base material layer that is arranged on the polytetrafluoroethylene layer and far away from the cellulose polymer layer. A surface of the base material layer far away from the polytetrafluoroethylene layer forms the second side surface. The base material layer comprises a non-woven fabric. A thickness of the non-woven fabric is 30-85% that of the entire membrane, and the thickness of the non-woven fabric is 60-300 μm.

In the present disclosure, mutual permeation between the base layer and the cellulose polymer layer increases overall flux and peeling strength so as to prolong the service life, however, the cellulose ultrafiltration membrane is relatively low in surface strength, and therefore in subsequent membrane hydrolysis and washing during the preparation, or when a filtration product is prepared (such as an ultrafiltration membrane package or a filter core), the surface of the cellulose ultrafiltration membrane inevitably contacts with some grids with a certain strength, whereas since filtration is often conducted by using a high pressure (when filtration is carried out using the filter membrane, the larger the pressure, the faster the filtration speed, and the higher the economic benefit per unit time) in a case that conditions are permitted when in preparation and filtration use, the surface of the ultrafiltration membrane is easily squeezed by grids, leading to the fractured surface of the ultrafiltration membrane so as to affect the integrity of the surface of the ultrafiltration membrane. However, in the present disclosure, the non-woven fabric is used as the base material layer, which makes the ultrafiltration membrane have higher strength. Furthermore, the non-woven fabric base material layer has a certain compressible ability, and therefore when high-pressure filtration is conducted, the non-woven fabric base material layer is compressed, so as to take a good buffer effect to prevent the surface of the ultrafiltration membrane from receiving a larger force, thereby leading to the damage of the integrity of the surface of the ultrafiltration membrane and then resulting in a poor filtration effect. The thickness of the non-woven fabric is 30-85% that of the entire membrane, and the thickness of the non-woven fabric is 60-300 μm, this is because a proportion of the thickness of the non-woven fabric accounting for the thickness of the entire membrane should not be too small, and a good buffer effect cannot be achieved if too small; and at the same time, the proportion of the thickness of the non-woven fabric accounting for the thickness of the entire membrane should not be too large, the ultrafiltration membrane is extremely prone to compression and deformation if too large, and meanwhile it is difficult for the ultrafiltration membrane to be recovered to its original thickness after deformation, which leads to a change in the overall working condition of the membrane when in subsequent use, resulting in different filtration efficiencies between different batches.

Further, the air permeability of the non-woven fabric is greater than 50 cc/cm²/sec, the fiber thickness of the non-woven fabric is 5-30 μm, and the gram weight of the non-woven fabric is 15-40 g/m².

In the present disclosure, the use of the non-woven fabric as the base material layer also affects the flux of the membrane to a certain extent, thus when the air permeability of the non-woven fabric is greater than 50 cc/cm²/sec, the base material layer has a rapid flow rate to prevent the influence of the base material layer on the flux of the entire membrane. Meanwhile, the non-woven fabric has a fiber thickness of 5-30 μm and a gram weight of 15-40 g/m², so that the non-woven fabric has moderate compressibility, ensuring the integrity of the cellulose ultrafiltration membrane.

The thickness and fiber thickness of the non-woven fabric and the thickness of the entire membrane are obtained by performing morphology characterization on a membrane structure using a scanning electron microscope followed by performing measurement utilizing computer software (such as Matlab and NIS-Elements), or in a manual manner and then performing calculation; of course, those skilled in the art also obtain the above parameters (such as the thickness of the entire membrane is obtained by freeze drying a filter membrane and then performing measurement using a measurement tool) through other measurement means, and the above measurement means are only for reference.

Further, a thickness ratio of the cellulose polymer layer to the polytetrafluoroethylene layer is 0.1-3, the thickness of the cellulose polymer layer is 1.5-60 μm, and the thickness of the polytetrafluoroethylene layer is 15-90 μm.

In the present disclosure, due to the existence of the non-woven fabric base material layer, the cellulose ultrafiltration membrane is given a certain mechanical strength while the cellulose polymer layer and the polytetrafluoroethylene layer have relatively thin thickness, wherein, the thickness ratio of the cellulose polymer layer to the polytetrafluoroethylene layer is 0.1-3, the thickness of the cellulose polymer layer is 1-55 μm, the thickness of the polytetrafluoroethylene layer is 15-90 μm, and the relatively thin cellulose polymer layer and polytetrafluoroethylene layer thicknesses make the cellulose ultrafiltration membrane have higher flux.

Further, the thickness of the binding layer is 10-100% that of the polytetrafluoroethylene layer, and the thickness of the binding layer is 10-100 μm.

In the present disclosure, the thickness of the binding layer is 10-100 μm, and the thickness of the binding layer is greater than 10% that of the polytetrafluoroethylene layer, in such the way, on the one hand, it is ensured that the cellulose ultrafiltration membrane has good mechanical strength and peeling strength, and on the other hand, the permeation of the cellulose polymer into the polytetrafluoroethylene layer in the binding layer affects its flux, but the polytetrafluoroethylene layer is relatively thin, so the cellulose ultrafiltration membrane has relatively high flux if even the cellulose polymer permeates in the thickness direction of the polytetrafluoroethylene layer.

Further, the base layer is the polytetrafluoroethylene layer, the thickness ratio of the cellulose polymer layer to the polytetrafluoroethylene layer is 0.02-1, the thickness of the cellulose polymer layer is 1.5-60 μm, and the thickness of the polytetrafluoroethylene is 100-300 μm.

Further, the PMI average pore size of the polytetrafluoroethylene layer has a PMI average pore size of 1-20 μm and a porosity of 60-90%; and the surface roughness of the polytetrafluoroethylene layer is 0.7-2 μm.

In the present disclosure, the polytetrafluoroethylene layer has the PMI average pore size of 1-20 μm and the porosity of 60-90%, so as to ensure that the cellulose polymer well permeate into the polytetrafluoroethylene layer, thereby improving the peeling strength of the cellulose ultrafiltration membrane; if the pore size is too small or the porosity is too low, too few cellulose polymers permeate, and layering occurs during the use, leading to a decrease in filtration performance; if the average pore size and the porosity are too large, the membrane-casting solution is prone to completely permeate into the polytetrafluoroethylene layer during the preparation, leading to a fact that phase separation cannot be carried out to form the ultrafiltration layer. In the present disclosure, the porosity is tested by using a mercury intrusion method, a density method, a dry wet membrane weighing method and the like. Meanwhile, the surface roughness of the polytetrafluoroethylene layer is 0.7-2 μm, under this roughness, the surface of the polytetrafluoroethylene layer is relatively flat, the prepared ultrafiltration membrane layer has good integrity and also has a certain roughness so that the cellulose polymer layer is better adhered to the surface of the polytetrafluoroethylene layer, increasing the peeling strength; if the roughness is too high, the prepared ultrafiltration layer easily has too many defects, leading to damaged integrity. The roughness involved in the present disclosure is measured by using a roughness tester, a super depth of field microscope or other instruments.

Further, the water contact angle of the surface of the polytetrafluoroethylene layer is <80°, and the water contact angle of the second side surface is larger than that of the first side surface by no greater than 50°.

Further, a dry membrane is infiltrated into water to be wetted within 5 s.

In the present disclosure, to make the cellulose polymer well permeate into the polytetrafluoroethylene layer, it is needed to ensure that the surface of the polytetrafluoroethylene layer has good hydrophily. When the water contact angle of the surface of the polytetrafluoroethylene layer is <80°, or when the dry membrane is infiltrated into water to be wetted within 5 s, a membrane preparing solution rapidly permeates during the preparation so that the prepared cellulose ultrafiltration membrane has good peeling strength; meanwhile, in the prepared cellulose ultrafiltration membrane, the water contact angle of the second side surface is larger than that of the first side surface by no greater than 50°, this is because during the preparation, a coagulating bath needs to permeate from the second side surface to ensure that the cellulose ultrafiltration membrane in the binding layer timely undergoes phase separation, however, if the second side surface is too hydrophobic, it is easy to result in too late phase separation in the binding layer so that the finally prepared cellulose polymer layer is too thick and the cellulose polymer in the binding layer is insufficient, which affects not only the flux but also the composite performance of the cellulose ultrafiltration membrane.

In the present disclosure, a water contact angle refers to a regular contact angle formed at the moment (within 0.4 s) when 10-100 μl of water drops are uniformly distributed on the surface of the material by testing via a contact angle tester based on water as a testing solution.

Further, the roughness of the first side surface is 0.1-2.5 μm, the pore area rate of the first side surface is 1-10%, and the water contact angle of the first side surface is 10-55°.

In the present disclosure, the cellulose ultrafiltration membrane is generally used for concentration, purification and separation of biological macromolecules, i.e., protein substances. To ensure the yield of a protein and reduce the non-specific adsorptivity of the first side surface in this process, the first side surface needs to have a certain hydrophily. In the present disclosure, the water contact angle of the first side surface of the cellulose ultrafiltration membrane is 10-55°, wherein, the water contact angle refers to a regular contact angle formed at the moment (within 0.4 s) when 10-100 μl of water drops are uniformly distributed on the surface of the material by testing via a contact angle tester based on water as a testing solution, on this basis, the cellulose ultrafiltration membrane ensures that it has relatively low protein adsorbability in production and application of protein products, thereby ensuring a relatively high protein yield. At the same time, the pore area rate of the first side surface is 1-10%, which ensures that the first side surface has relatively few pores, and a dense pore structure is matched with a relatively small pore size to ensure the interception efficiency of the ultrafiltration layer of the cellulose ultrafiltration membrane; and the roughness of the first side surface is 0.1-2.5 μm, so that the first side surface has a certain roughness and is not too smooth, thereby preventing a phenomenon of concentration polarization, avoiding that the pores are blocked after filtration for a short period of time and causing a significant decrease in flux; however, the first side surface cannot be too rough, too high roughness increases a shear force that is received by a protein on the surface of the cellulose ultrafiltration membrane during the filtration, leading to a decrease in effective protein yield.

Further, the ultrafiltration layer has ultrafiltration fibers forming a porous structure, and the SEM average diameter of the ultrafiltration fiber is 20-60 nm;
the support layer has support fibers forming the porous structure, and the SEM average diameter of the support fiber is 20-85 nm;
an SEM average diameter ratio of the support fiber to the ultrafiltration fiber is 1.2-2.4.

The existence of the ultrafiltration fiber in the ultrafiltration layer ensures the stability of the pores inside the ultrafiltration layer and prevents the collapse or shrinkage of the pores, and meanwhile the support fiber inside the support layer takes a good support effect on the ultrafiltration layer; wherein, the filtration flow rate of the ultrafiltration layer is reduced if the ultrafiltration fibers and support fibers are too thick, thereby causing a decrease in overall flux, and a good effect of supporting and stabilizing the pores cannot be achieved if the ultrafiltration fiber and the support fiber are too thin. When the SEM average diameter ratio of the support fiber to the ultrafiltration fiber is in a range of 1.2-2.4, the cellulose ultrafiltration membrane has relatively high mechanical strength and filtration stability.

Further, the thickness of the ultrafiltration layer is 0.1-5 μm, the thickness of the support layer is 0.5-50 μm, and the thickness ratio of the support layer to the ultrafiltration layer is 2-13.

To ensure that the ultrafiltration layer takes a good interception effect during the filtration, the ultrafiltration layer needs to have a certain thickness, however, if the ultrafiltration is too thick, not only the interception efficiency cannot be further improved, but also the overall flux of the membrane is reduced; the support layer takes an effect of supporting and protecting the ultrafiltration layer, which not only increases the pore stability of the ultrafiltration layer, but also improves the integrity of the ultrafiltration layer. Therefore, the support layer needs to have a certain thickness, however, a too thick support layer easily leads to a decrease in the overall flow rate of the membrane, and therefore the cellulose ultrafiltration membrane will have relatively high mechanical strength and relatively good integrity if the thickness ratio of the support layer to the ultrafiltration layer is controlled in a range of 2-13.

Further, the SEM average pore size of the support layer gradually increases in a fluid flow direction, with a change gradient of 20-450 nm/1 μm.

The SEM average pore size of the support layer gradually increases in a fluid flow direction, i.e., the pore size close to the ultrafiltration layer is small, which increases the support of the ultrafiltration layer, while the pore size close to the polytetrafluoroethylene layer is relatively large, which endows the entire membrane with high flux. However, too large change gradient easily causes a decrease in the overall strength of the cellulose ultrafiltration membrane, thereby reducing the service life of the cellulose ultrafiltration membrane.

The thickness, pore size and fiber diameter of each layer of the cellulose ultrafiltration membrane are obtained by performing morphology characterization on a membrane structure using a scanning electron microscope followed by performing measurement utilizing computer software (such as Matlab and NIS-Elements) or in a manual manner and then performing calculation; of course, those skilled in the art also obtain the above parameters (for example, the thickness of each layer is obtained by freeze drying a filter membrane and then performing measurement using a measurement tool) through other measurement means, and the above measurement means are only for reference.

Further, the thickness of the ultrafiltration membrane is 130-420 μm;
the standard molecular weight cut off of the ultrafiltration membrane is 1 K-750 K;
the tensile strength of the ultrafiltration membrane is no less than 10 MPa;
Under the conditions that a pressure is 0.68 bar and a temperature is 25° C., a water flux of a 100 K cellulose ultrafiltration membrane is 1-1.8 mL/min/cm².

When the thickness of the membrane is too small, the mechanical strength of the membrane is relatively low; when the thickness of the membrane is too large, the filtration time of the membrane is too long, and the time cost is too large; the filter membrane of the present disclosure is a composite membrane, so the pore sizes of most regions of the filter membrane are relatively large; to ensure the mechanical properties, the overall thickness of the membrane is relatively large, by researches, the appropriate thickness of the membrane is 130-420 μm so as to ensure that the filter membrane has not only relatively high mechanical strength, but also relatively short filtration time and low time cost; in the present disclosure, the interception rate of the ultrafiltration membrane on substances with a molecular weight of 1 KD-750 KD is greater than 90%, with a high interception efficiency, indicating that the membrane is especially suitable for application in biological purification and meeting the demands of practical application; the protein yield of the membrane is no less than 90%, indicating that an effective substances proteins in fluid are not easily adsorbed onto the membrane, in such the way, on the one hand, the pores of the membrane cannot be blocked to ensure that the filter membrane still has relatively high service life, and on the other hand, the content changes of effective substances, i.e., various proteins, in fluid are extremely little, the proteins are substantially not lost, and economic benefits are ensured. An important indicator for evaluating the mechanical strength of the filter membrane is the tensile strength of the filter membrane. Under certain conditions, the larger the tensile strength of the filter membrane, the better the mechanical strength of this filter membrane. In the present disclosure, the wet tensile strength of the filter membrane is no less than 10 MPa (measured under the wetting condition of the membrane), the filter membrane has relatively large tensile strength, relatively good mechanical properties and a relatively high industrial practical value, thereby completely meeting the demands of the market; and meanwhile by testing the flow rate of the filter membrane, it is indicated that the filter membrane has a relatively large flow rate, short filtration time and relatively low time cost.

Further, the surface of the polytetrafluoroethylene layer forming the binding layer is a polytetrafluoroethylene layer binding face. The binding face comprises nodes and fiber filaments, wherein the nodes are interconnected by the fiber filaments.

The polytetrafluoroethylene layer has different structures according to different preparation processes. However, the inventor has found that using the polytetrafluoroethylene layers with any structures as the base layers does not always have a good effect, and using the polytetrafluoroethylene layers with nodes that are interconnected by the fiber filaments as the base layers has a better effect. First, compared with polytetrafluoroethylene membranes with other structure forms (for example, which are prepared by a sintering method), the surface of the polytetrafluoroethylene membrane with a node and fiber filament structure is more flat as the fiber filaments between the nodes are obtained by stretching, the polytetrafluoroethylene membrane does not have raised ends, and therefore using the polytetrafluoroethylene membrane as the base layer achieves good composite ultrafiltration membrane integrity; second, the surface of the polytetrafluoroethylene membrane with the node and fiber filament structure has a high open area (fiber filaments are relatively thin and directly perforated), which makes it easier for the cellulose polymer layer to permeate and form a permeable layer compared to other structural forms while increasing the composite ability and improving the peeling strength; and finally, the nodes have relatively high strength, the fiber filaments are relatively prone to deformation, so their binding increases the overall strength elasticity of the membrane.

Further, an area of the nodes accounting for the polytetrafluoroethylene layer binding face is S1;
an area of the fiber filaments accounting for the polytetrafluoroethylene layer binding face is S2;
the S1:S2 is 0.13-7; the S1 is 4-40%; and the S2 is 5-35%.

In the present disclosure, if the area S1 of the nodes accounting for the polytetrafluoroethylene layer binding face is too small and the area S2 of the fiber filaments accounting for the polytetrafluoroethylene layer binding face is too large, it is easy to generate a situation that the strength of the base material layer is relatively low; if the area S1 of the nodes accounting for the polytetrafluoroethylene layer binding face is too large and the area S2 of the fiber filaments accounting for the polytetrafluoroethylene layer binding face is too small, it is easy to generate a phenomenon that the cellulose polymer layer is difficult to permeate so that a solute accumulation effect occurs, leading to a decrease in flux, and meanwhile resulting in a decrease in peeling strength due to too few cellulose polymer layers binding with the fiber filaments after permeation. Furthermore, too small proportion of the fiber filaments also leads to a decrease in elasticity of the entire membrane so as to generate a phenomenon that the ultrafiltration membrane is too fragile.

The node proportion, width and density as well as fiber filament proportion, width and density on the polytetrafluoroethylene binding face are obtained by performing morphology characterization on the membrane structure using a scanning electron microscope followed by performing measurement utilizing computer software (such as Matlab and NIS-Elements) or in a manual manner and performing corresponding calculation; in the preparation process of the membrane, the distribution of various features such as node width and density as well as fiber width and density is roughly uniform and basically consistent in a direction vertical to the thickness of the membrane (if the membrane is in a flat plate membrane form, this direction is a plane direction; and if the membrane is in a hollow fiber membrane form, this direction is a direction vertical to a radius); thus, the overall node width and density as well as fiber width and density of this plane are reflected by node width and density as well as fiber width and density of partial regions on a corresponding plane; during the practical measurement, the outer surface of the membrane is characterized by using an electron microscope to obtain a corresponding SEM image, and since the node proportion, width and density as well as fiber width and density of the outer surface of the membrane are substantially uniform, a certain area such as 1000 μm² (40 μm is multiplied by 25 μm) or 10000 μm² (100 μm multiplied by 100 μm) is selected, the specific area is determined according to practical situations and then the node width and density as well as fiber width and density on this area are measured by using a corresponding computer software or in a manual manner, thereby obtaining the node proportion, width and density as well as fiber filament proportion, width and density of this surface; of course, those skilled in the art obtain the above parameters through other measurement means, and the above measurement means are only for reference.

Further, the average width of the nodes is 1-6 μm, and a difference between the largest width and the smallest width of the node is <7 μm; the average width of the fiber filaments is 0.1-1.2 μm, and a difference between the largest width and the smallest width of the fiber filaments is <1.5 μm.

The average width of the nodes affects the mechanical strength of the polytetrafluoroethylene layer. If the average width of the nodes is too small, polytetrafluoroethylene as the base layer has relatively low strength, leading to a decrease in the strength of the entire membrane; if the average width of the nodes is too large, it is easy to lead to a fact that the membrane-casting solution cannot well permeate at the nodes during the preparation, which not only affects the peeling strength of the ultrafiltration membrane but also increases the defects of the ultrafiltration layer to reduce the integrity of the ultrafiltration layer.

Further, the quantity of the connected celluloses along a length of 50 μm in a direction of the nodes is 15-70.

The density of the fiber filament significantly affects the permeation and binding of the membrane. If the density is too small, the overall strength is reduced, and meanwhile there are no enough quantity of fiber filaments in the binding layer to bind with the support layer, leading to a decrease in peeling strength; if the density is too large, the overall surface pores are reduced, and the membrane-casting solution cannot well permeate during the preparation, leading to a decrease in the peeling strength of the ultrafiltration membrane.

Further, the material of the cellulose polymer layer comprises one or more of regenerated celluloses and cellulose esters.

The present disclosure further provides a preparation method of a cellulose ultrafiltration membrane, comprising:
S1: preparing a membrane-casting solution comprising the following substances in parts by weight:
10-30 parts of cellulose polymer, 40-60 parts of polar solvent and 20-40 parts of pore-forming agent;
S2: casting the membrane-casting solution onto a hydrophilic base to form a liquid membrane, wherein the hydrophilic base is a polytetrafluoroethylene porous membrane;
the water contact angle of the polytetrafluoroethylene porous membrane surface is less than 80°, and the pore size of the polytetrafluoroethylene porous membrane is greater than 0.8 μm;
S3: performing phase separation and solidification, i.e., immersing the liquid membrane into a coagulating bath for phase separation and solidification to prepare a finished membrane; and
S4: placing the finished membrane into a sodium hydroxide aqueous solution for hydrolysis, and then washing after hydrolysis to form the cellulose ultrafiltration membrane.

Further, the cellulose polymer is at least one of cellulose nitrate, cellulose acetate and regenerated cellulose.

The cellulose acetate is selected from one or more of cellulose diacetate, cellulose triacetate, cellulose nitrate, cellulose acetate butyrate and cellulose acetate propionate.

Further, the polar solvent comprises at least one of acetone, dioxane, dimethylacetamide, N-methylpyrrolidone, acetic acid, propionic acid, butyric acid, and valeric acid;
the pore-forming agent comprises at least one of polyvinyl pyrrolidone, polyethylene glycol and polyvinyl alcohol.

Further, the viscosity of the membrane-casting solution is 6000-40000 cpa·s.

Further, the lasting time of the phase separation and solidification is 5-60 s, the coagulating bath is water, and the phase separation temperature is 20-40° C.

Further, the concentration of the sodium hydroxide aqueous solution is 0.01 mol/L-1 mol/L; and the hydrolysis temperature is 30° C.-80° C., and the hydrolysis time is 40 min-200 min.

Further, the preparation of the cellulose ultrafiltration membrane comprises cross linking;
the cross linking is that the cellulose ultrafiltration membrane is subjected to cross linking with an aqueous cross linking agent under an alkaline environment for 20-400 min at the temperature of 30° C.-60° C.; and the cross linking agent is at least one of halogenated epoxide, double epoxide, double halogenated alkane and double halogenated alcohol.

In the preparation process of the present disclosure, first, the membrane-casting solution is prepared, wherein, the cellulose polymer has relatively good hydrophily and relatively low non-specific adsorptivity, and therefore is extremely suitable for purification, concentration and separation of a protein, and is used as the solute of the membrane-casting solution. The polar solvent is used for forming a solvent system to sufficiently dissolve the cellulose polymer to form a uniform and stable membrane-casting solution. The pore forming agent not only effectively controls the viscosity of the system and inhibits the formation of macropores on the membrane during the phase separation, but also effectively improves the flow rate stability of the membrane. In addition, the hydrophily of the finished membrane is greatly improved, so that the membrane has relatively high hydrophily to reduce the adsorption of the protein.

Subsequently, the membrane-casting solution is cast onto a base material to form a liquid membrane. In the present disclosure, to make the cellulose ultrafiltration membrane have relatively high flux, the solute in the membrane-casting solution needs to permeate into a microporous layer of the base material during the casting. The inventor has found that base membranes made of different materials are used, and therefore the compatibility between the base membranes and the cellulose polymers varies greatly; a hydrophilic polytetrafluoroethylene porous membrane is used as a base material layer, when the water contact angle of the surface of the polytetrafluoroethylene porous membrane is less than 80° and the pore size of the polytetrafluoroethylene porous membrane is greater than 0.8 μm, the membrane-casting solution permeates into the polytetrafluoroethylene porous membrane to form the binding layer, thereby eliminating the phenomenon of solute accumulation so that the prepared ultrafiltration membrane has good flux while the binding layer also gives a better composite performance between the cellulose polymer layer and the polytetrafluoroethylene layer in the finally prepared cellulose ultrafiltration membrane, i.e., the peeling strength between the cellulose polymer layer and the polytetrafluoroethylene layer is improved to prevent a phenomenon of peeling occurring during the use or between the cellulose polymer layer and the polytetrafluoroethylene layer; preferably, the polytetrafluoroethylene porous membrane has a PMI average pore size of 1-20 μm, a porosity of 60-90% and the surface roughness of 0.7-2 μm, and meanwhile the surface comprises nodes and fiber filaments, wherein the nodes are interconnected through the fiber filaments, under such the conditions, the membrane-casting solution better permeates to obtain a cellulose ultrafiltration membrane with better composite performance and filtration performance. At the same time, in the step of casting, the viscosity of the membrane-casting solution is also one of the factors determining good permeation. In the present disclosure, the viscosity of the membrane-casting solution is 6000-40000 cpa·s, thereby ensuring that the cellulose ultrafiltration membrane has a proper thickness, and ideal membrane pore structure and pore size, and then achieving good composite performance and filtration performance; this is because too high viscosity of the membrane-casting solution makes the membrane-casting solution not well permeate into the base material layer, or even causes a phenomenon that the solvent permeates and the solute passes, leading to the accumulation of the solute on the surface of the base material layer to cause a decrease in final composite performance and filtration performance, too low viscosity leads to complete permeation of the membrane-casting solution so as not to finally form an ultrafiltration layer used for interception, and similarly not to meet practical demands.

The subsequent phase separation and coagulation is that the base material coated with the liquid membrane is immersed into water for phase separation and solidification, and the lasting time of phase separation and coagulation is 5-60 s. Proper phase separation is performed on the membrane-casting solution by selecting a proper membrane-casting solution and proper phase separation time, so as to ensure that a finished membrane with an ideal membrane pore size is obtained. Meanwhile, in the present disclosure, a hydrophilic and macroporous polytetrafluoroethylene porous membrane is used as the base material, during the phase separation, the coagulating bath more easily enters from the bottom surface of the base material layer so that the cellulose polymer permeating into the base material layer is similarly subjected to phase separation and solidification relatively earlier, thereby grabbing the solute outside the upper surface of the base material layer, in such the way, on the one hand, the phenomenon of solute accumulation is relieved, and on the other hand, the support layer is relatively thinned due to a decrease in solute outside the polytetrafluoroethylene layer, thereby increasing the flux.

Finally, a solid membrane is formed by hydrolysis using a sodium hydroxide aqueous solution followed by washing. Furthermore, in combination with practical demands, cross linking is also performed in the future, hydroxyl in the solid membrane reacts with functional groups such as epoxy and halogen in the process of cross linking modification, so that the membrane structure has higher mechanical strength and is not prone to swelling, and meanwhile the membrane has improved alkali resistance and longer service life. At the same time, it is more beneficial to efficiently intercept those biological molecules with small molecular weights (such as 3 K and 5 K biological molecules).

In the present disclosure, a microporous membrane comprising a polytetrafluoroethylene layer is used as a base layer, first, the surface of the polytetrafluoroethylene layer is relatively flat and strong in solvent resistance, the defects of the cellulose polymer layer in the prepared ultrafiltration membrane are relatively small, and therefore the integrity of the ultrafiltration membrane is relatively good; and the base layer takes a support effect on the cellulose polymer layer so as to ensure that the entire membrane has good mechanical strength and relatively high pressure resistance, and is suitable for long-term stable filtration under the action of a relatively high pressure; meanwhile the cellulose polymer permeates into the polytetrafluoroethylene layer to form a binding layer, thereby eliminating the phenomenon of solute accumulation so that the prepared ultrafiltration membrane has good flux and composite performance, preventing the phenomenon of peeling during the use; and finally, during the subsequent phase separation, the coagulating bath more easily enters from the second side surface so that the cellulose polymer in the binding layer similarly undergoes phase separation and solidification relatively earlier, thereby grabbing the solute outside the polytetrafluoroethylene layer, ensuring that the SEM average pore size of the first side surface is uniform while relieving the phenomenon of solute accumulation and facilitating the regulation of the thickness of the support layer, so that the support layer is relatively thinned, thereby increasing the flux.

### BRIEF DESCRIPTION OF THE DRAWINGS

Next, the present disclosure will be further illustrated in combination with drawings.

FIG. 1 is an SEM map of a first side surface of an ultrafiltration membrane prepared in Embodiment 1 according to the present disclosure;

FIG. 2 is an SEM map of a cross section of an ultrafiltration membrane prepared in Embodiment 1 according to the present disclosure;

FIG. 3 is an SEM map of a polytetrafluoroethylene layer binding face in a base layer in Embodiment 1 according to Embodiment 1;

FIG. 4 is an SEM map of a first side surface of an ultrafiltration membrane prepared in Embodiment 10 according to the present disclosure;

FIG. 5 is an SEM map of a cross section of an ultrafiltration membrane prepared in Embodiment 10 according to the present disclosure;

FIG. 6 is an SEM map of a first side surface of an ultrafiltration membrane prepared in Embodiment 12 according to the present disclosure;

FIG. 7 is an SEM map of a cross section of an ultrafiltration membrane prepared in Embodiment 12 according to the present disclosure;

FIG. 8 shows a base layer used during the preparation in Embodiment 17 according to the present disclosure, wherein magnification factor is 2000×; and

FIG. 9 is a diagram of a membrane package diffusion flow test device according to the present disclosure.

### DETAILED DESCRIPTION OF THE EMBODIMENTS

The technical solutions in the embodiments of the present disclosure will be clearly and completely described below with reference to the accompanying drawings. Obviously, the described embodiments are only a part of the embodiments of the present disclosure, rather than all of the embodiments. Based on the embodiments of the present disclosure, all other embodiments obtained by those of ordinary skill in the art without creative efforts fall within the scope of protection of the present disclosure.

To more clearly understand the above objective, features and advantages of the present disclosure, the present disclosure will be further described in detail in combination with drawings and specific embodiments below. It is noted that without conflict, the embodiments of the present disclosure and the features in the embodiments can be combined with each other.

The following description demonstrates many specific details to facilitate sufficient understanding of the present disclosure, however, the present disclosure is also implemented by using other methods different from those described here, thus the protective scope of the present disclosure is not limited by specific embodiments disclosed below.

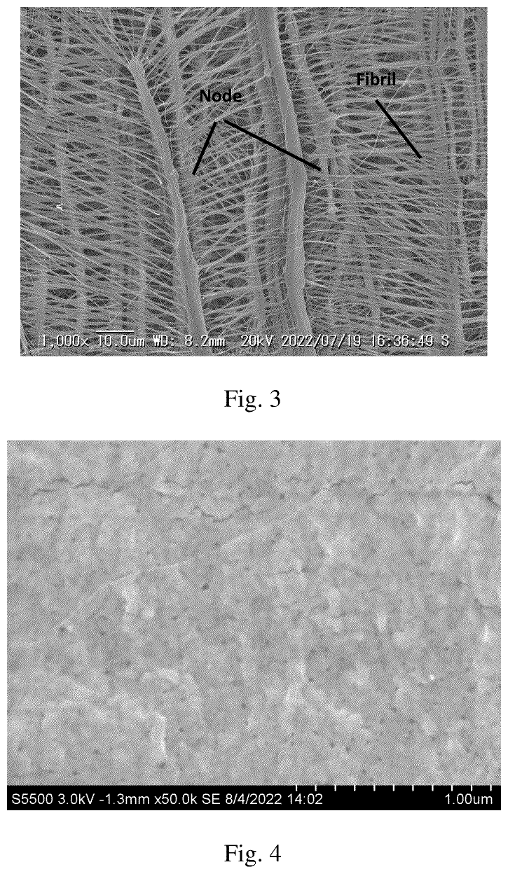

Embodiment 1: A preparation method of a cellulose ultrafiltration membrane comprises the following steps:
S1: a membrane-casting solution was prepared, the membrane-casting solution comprising the following substances in parts by weight:
10 parts of cellulose diacetate, 40 parts of polar solvent acetone and 22 parts of pore-forming agent polyvinyl alcohol, wherein the viscosity of the membrane-casting solution is 6000 cps;
S2: the membrane-casting solution was cast onto a base layer to form a liquid membrane; the hydrophilic base was a polytetrafluoroethylene porous membrane; the polytetrafluoroethylene layer binding face in the base layer is as shown in FIG. 3;
S3: phase separation and solidification was performed, i.e., the liquid membrane was immersed into coagulating bath water for phase separation and solidification of 10 s at 25° C. to prepare a finished membrane;
S4: the finished membrane was placed into a 0.1 mol/L sodium hydroxide aqueous solution for hydrolysis of 120 min at 60° C., and then the membrane was washed after hydrolysis to form the cellulose ultrafiltration membrane; and
S5: the membrane formed after hydrolysis was placed in an alkaline environment at pH of 10 to undergo cross linking with an aqueous cross linking agent, the obtained product was washed after cross linking was ended to obtain an ultrafiltration membrane; wherein the cross linking agent was epoxy chloropropane, the concentration of the cross linking agent in the aqueous solution was 10%, the cross linking time was 150 min, and the temperature was 45° C.

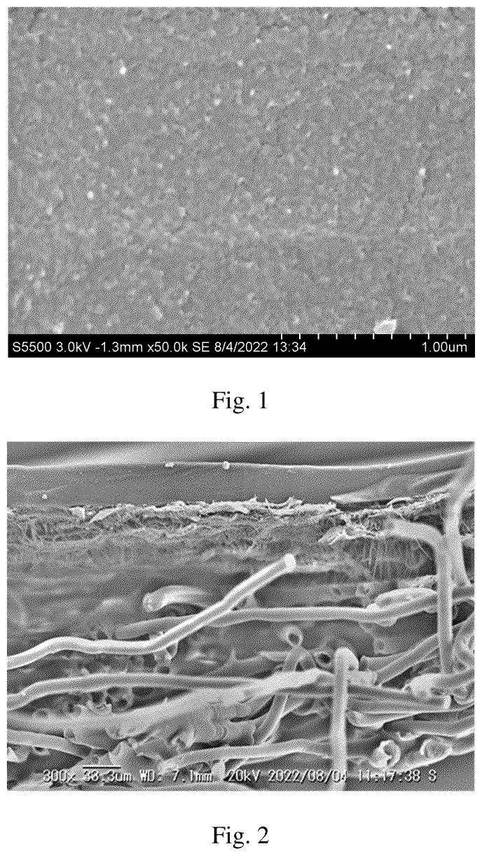

The morphology of the prepared ultrafiltration membrane is as shown in FIG. 1-FIG. 2.

Embodiment 2: A preparation method of a cellulose ultrafiltration membrane comprises the following steps:
S1: a membrane-casting solution was prepared, the membrane-casting solution comprising the following substances in parts by weight:
12 parts of cellulose diacetate, 43 parts of polar solvent dioxane and 23 parts of pore-forming agent polyethylene glycol; and the viscosity of membrane-casting solution being 7000 cps;
S2: the membrane-casting solution was cast onto a base layer to form a liquid membrane; and the hydrophilic base was a polytetrafluoroethylene porous membrane;
S3: phase separation and solidification was performed, i.e., the liquid membrane was immersed into coagulating bath water for phase separation and solidification of 15 s at 25° C. to prepare a finished membrane;
S4: the finished membrane was placed into a 0.1 mol/L sodium hydroxide aqueous solution for hydrolysis of 120 min at 60° C., and then the membrane was washed after hydrolysis to form the cellulose ultrafiltration membrane; and
S5: the membrane formed after hydrolysis was placed in an alkaline environment at pH of 10 to undergo cross linking with an aqueous cross linking agent, the obtained product was washed after cross linking was ended to obtain an ultrafiltration membrane; wherein the cross linking agent was epoxy chloropropane, the concentration of the cross linking agent in the aqueous solution was 10%, the cross linking time was 100 min, and the temperature was 50° C.

Embodiment 3: A preparation method of a cellulose ultrafiltration membrane comprises the following steps:
S1: a membrane-casting solution was prepared, the membrane-casting solution comprising the following substances in parts by weight:
10 parts of cellulose diacetate, 41 parts of polar solvent dimethylacetamide and 25 parts of pore-forming agent polyvinyl pyrrolidone; and the viscosity of membrane-casting solution being 6000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 20 s at 25° C. to prepare a finished membrane;
S4: the finished membrane was placed into a 0.3 mol/L sodium hydroxide aqueous solution for hydrolysis of 60 min at 40° C., and then the membrane was washed after hydrolysis to form the cellulose ultrafiltration membrane; and
S5: the membrane formed after hydrolysis was placed in an alkaline environment at pH of 10 to undergo cross linking with an aqueous cross linking agent, the membrane was washed after cross linking was ended to obtain an ultrafiltration membrane; wherein the cross linking agent was epoxy chloropropane, the concentration of the cross linking agent in the aqueous solution was 10%, the cross linking time was 70 min, and the temperature was 55° C.

Embodiment 4: A preparation method of a cellulose ultrafiltration membrane comprises the following steps:
S1: a membrane-casting solution was prepared, the membrane-casting solution comprising the following substances in parts by weight:
13 parts of cellulose diacetate, 45 parts of polar solvent N-methylpyrrolidone and 20 parts of pore-forming agent polyvinyl alcohol; and the viscosity of membrane-casting solution being 8000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 10 s at 30° C. to prepare a finished membrane;
S4: the finished membrane was placed into a 0.3 mol/L sodium hydroxide aqueous solution for hydrolysis of 60 min at 40° C., and then the membrane was washed after hydrolysis to form the cellulose ultrafiltration membrane; and
S5: the membrane formed after hydrolysis was placed in an alkaline environment at pH of 10 to undergo cross linking with an aqueous cross linking agent, the membrane was washed after cross linking was ended to obtain an ultrafiltration membrane; wherein the cross linking agent was epoxy chloropropane, the concentration of the cross linking agent in the aqueous solution was 10%, the cross linking time was 250 min, and the temperature was 35° C.

Embodiment 5: A preparation method of a cellulose ultrafiltration membrane comprises the following steps:
S1: a membrane-casting solution was prepared, the membrane-casting solution comprising the following substances in parts by weight:
12 parts of cellulose diacetate, 42 parts of polar solvent acetone and 21 parts of pore-forming agent polyethylene alcohol; and the viscosity of membrane-casting solution being 7000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 15 s at 30° C. to prepare a finished membrane;
S4: the finished membrane was placed into a 0.3 mol/L sodium hydroxide aqueous solution for hydrolysis of 60 min at 40° C., and then the membrane was washed after hydrolysis to form the cellulose ultrafiltration membrane; and
S5: the membrane formed after hydrolysis was placed in an alkaline environment at pH of 10 to undergo cross linking with an aqueous cross linking agent, the membrane was washed after cross linking was ended to obtain an ultrafiltration membrane; wherein the cross linking agent was epoxy chloropropane, the concentration of the cross linking agent in the aqueous solution was 10%, the cross linking time was 350 min, and the temperature was 58° C.

Embodiment 6: A preparation method of a cellulose ultrafiltration membrane comprises the following steps:
S1: a membrane-casting solution was prepared, the membrane-casting solution comprising the following substances in parts by weight:
14 parts of cellulose diacetate, 44 parts of polar solvent acetone and 22 parts of pore-forming agent polyvinyl pyrrolidone; and the viscosity of membrane-casting solution being 9000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 20 s at 30° C. to prepare a finished membrane; and
S4: the finished membrane was placed into a 0.3 mol/L sodium hydroxide aqueous solution for hydrolysis of 80 min at 40° C., and then the membrane was washed after hydrolysis to form the cellulose ultrafiltration membrane;

Embodiment 7: A preparation method of a cellulose ultrafiltration membrane comprises the following steps:
S1: a membrane-casting solution was prepared, the membrane-casting solution comprising the following substances in parts by weight:
14 parts of cellulose diacetate, 43 parts of polar solvent dimethylacetamide and 24 parts of pore-forming agent polyvinyl alcohol; and the viscosity of membrane-casting solution being 10000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 30 s at 30° C. to prepare a finished membrane; and
S4: the finished membrane was placed into a 0.3 mol/L sodium hydroxide aqueous solution for hydrolysis of 90 min at 40° C., and then the membrane was washed after hydrolysis to form the cellulose ultrafiltration membrane.

Embodiment 8: A preparation method of a cellulose ultrafiltration membrane comprises the following steps:
S1: a membrane-casting solution was prepared, the membrane-casting solution comprising the following substances in parts by weight:
15 parts of cellulose diacetate, 44 parts of polar solvent N-methylpyrrolidone and 27 parts of pore-forming agent polyethylene glycol; and the viscosity of membrane-casting solution being 12000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 40 s at 30° C. to prepare a finished membrane;
S4: the finished membrane was placed into a 0.3 mol/L sodium hydroxide aqueous solution for hydrolysis of 100 min at 40° C., and then the membrane was washed after hydrolysis to form the cellulose ultrafiltration membrane.

Embodiment 9: A preparation method of a cellulose ultrafiltration membrane comprises the following steps:
S1: a membrane-casting solution was prepared, the membrane-casting solution comprising the following substances in parts by weight:
17 parts of cellulose diacetate, 48 parts of polar solvent acetone and 25 parts of pore-forming agent polyvinyl pyrrolidone; and the viscosity of membrane-casting solution being 16000 cps;
S2: the membrane-casting solution was cast to a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 20 s at 35° C. to prepare a finished membrane;
S4: the finished membrane was placed into a 0.2 mol/L sodium hydroxide aqueous solution for hydrolysis of 120 min at 50° C., and then the membrane was washed after hydrolysis to form the cellulose ultrafiltration membrane.

Embodiment 10: A preparation method of a cellulose ultrafiltration membrane comprises the following steps:
S1: a membrane-casting solution was prepared, the membrane-casting solution comprising the following substances in parts by weight:
19 parts of cellulose diacetate, 48 parts of polar solvent dioxane and 30 parts of pore-forming agent polyvinyl alcohol; and the viscosity of membrane-casting solution being 20000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 30 s at 35° C. to prepare a finished membrane; and
S4: the finished membrane was placed into a 0.3 mol/L sodium hydroxide aqueous solution for hydrolysis of 150 min at 50° C., and then the membrane was washed after hydrolysis to form the cellulose ultrafiltration membrane.

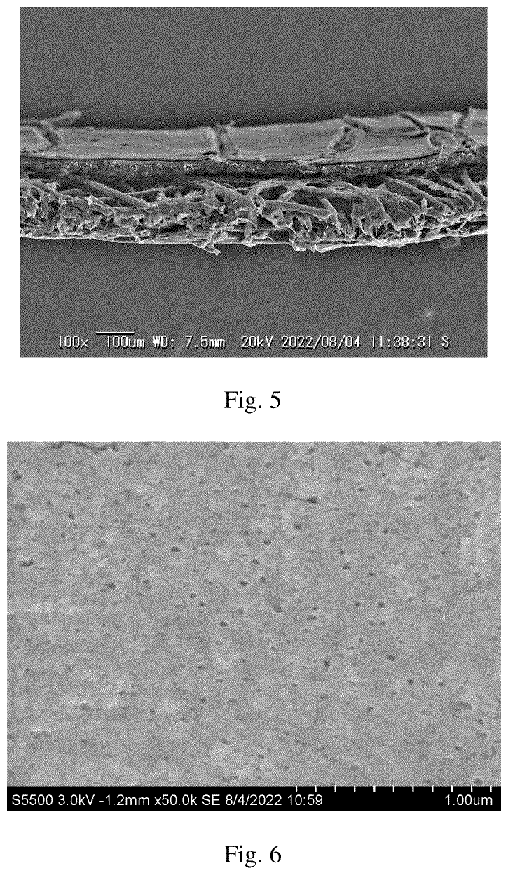

The morphology of the prepared ultrafiltration membrane is as shown in FIG. 4-FIG. 5.

Embodiment 11: A preparation method of a cellulose ultrafiltration membrane comprises the following steps:
S1: a membrane-casting solution was prepared, the membrane-casting solution comprising the following substances in parts by weight:
19 parts of cellulose diacetate, 49 parts of polar solvent dimethylacetamide and 33 parts of pore-forming agent polyethylene glycol; and the viscosity of membrane-casting solution being 24000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 35 s at 35° C. to prepare a finished membrane; and
S4: the finished membrane was placed into a 0.3 mol/L sodium hydroxide aqueous solution for hydrolysis of 170 min at 60° C., and then the membrane was washed after hydrolysis to form the cellulose ultrafiltration membrane.

Embodiment 12: A preparation method of a cellulose ultrafiltration membrane comprises the following steps:
S1: a membrane-casting solution was prepared, the membrane-casting solution comprising the following substances in parts by weight:
21 parts of cellulose diacetate, 51 parts of polar solvent N-methylpyrrolidone and 35 parts of pore-forming agent polyvinyl pyrrolidone; and the viscosity of membrane-casting solution being 27000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 40 s at 35° C. to prepare a finished membrane; and
S4: the finished membrane was placed into a 0.5 mol/L sodium hydroxide aqueous solution for hydrolysis of 60 min at 40° C., and then the membrane was washed after hydrolysis to form the cellulose ultrafiltration membrane.

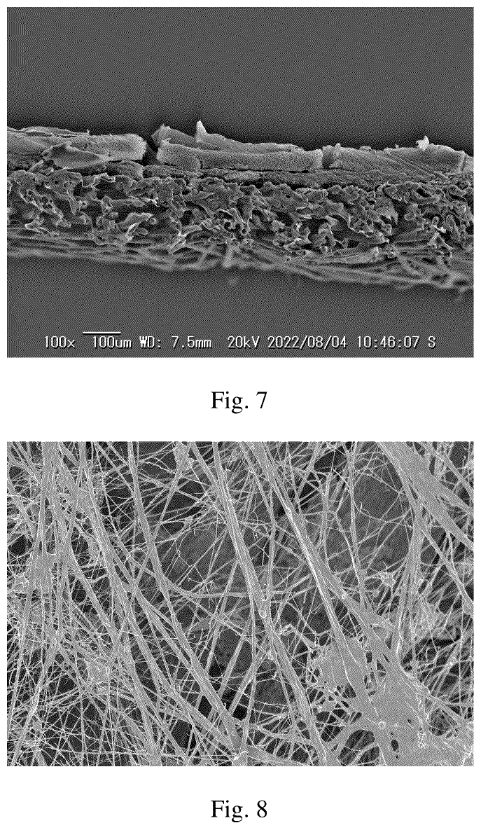

The morphology of the prepared ultrafiltration membrane is as shown in FIG. 6-FIG. 7.

Embodiment 13: A preparation method of a cellulose ultrafiltration membrane comprises the following steps:
S1: a membrane-casting solution was prepared, the membrane-casting solution comprising the following substances in parts by weight:
24 parts of cellulose polymer, 53 parts of polar solvent acetone and 35 parts of pore-forming agent polyvinyl alcohol; and the viscosity of membrane-casting solution being 29000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 50 s at 35° C. to prepare a finished membrane;
S4: the finished membrane was placed into a 0.5 mol/L sodium hydroxide aqueous solution for hydrolysis of 60 min at 70° C., and then the membrane was washed after hydrolysis to form the cellulose ultrafiltration membrane.

Embodiment 14: A preparation method of a cellulose ultrafiltration membrane comprises the following steps:
S1: a membrane-casting solution was prepared, the membrane-casting solution comprising the following substances in parts by weight:
25 parts of cellulose diacetate, 52 parts of polar solvent dioxane and 36 parts of pore-forming agent polyethylene glycol; and the viscosity of membrane-casting solution being 30000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 20 s at 40° C. to prepare a finished membrane; and
S4: the finished membrane was placed into a 0.5 mol/L sodium hydroxide aqueous solution for hydrolysis of 100 min at 50° C., and then the membrane was washed after hydrolysis to form the cellulose ultrafiltration membrane.

Embodiment 15: A preparation method of a cellulose ultrafiltration membrane comprises the following steps:
S1: a membrane-casting solution was prepared, the membrane-casting solution comprising the following substances in parts by weight:
27 parts of cellulose diacetate, 57 parts of polar solvent dimethylacetamide and 38 parts of pore-forming agent polyvinyl pyrrolidone; and the viscosity of membrane-casting solution being 34000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 40 s at 40° C. to prepare a finished membrane; and
S4: the finished membrane was placed into a 0.5 mol/L sodium hydroxide aqueous solution for hydrolysis of 120 min at 50° C., and then the membrane was washed after hydrolysis to form the cellulose ultrafiltration membrane.

Embodiment 16: A preparation method of a cellulose ultrafiltration membrane comprises the following steps:
S1: a membrane-casting solution was prepared, the membrane-casting solution comprising the following substances in parts by weight:
29 parts of cellulose nitrate, 59 parts of polar solvent N-methylpyrrolidone and 40 parts of pore-forming agent polyvinyl alcohol; and the viscosity of membrane-casting solution being 38000 cps;
S2: the membrane-casting solution was cast onto a base layer to form a liquid membrane; the hydrophilic base was a polytetrafluoroethylene porous membrane;
S3: phase separation and solidification was performed, i.e., the liquid membrane was immersed into coagulating bath water for phase separation and solidification of 50 s at 40° C. to prepare a finished membrane; and
S4: the finished membrane was placed into a 0.5 mol/L sodium hydroxide aqueous solution for hydrolysis of 100 min at 60° C., and then the membrane was washed after hydrolysis to form the cellulose ultrafiltration membrane.

Embodiment 17: this embodiment was different from Embodiment 1 in that hydrophilic polytetrafluoroethylene (PTFE) with other structures as shown in FIG. 8 was used as a base layer.

Comparative Embodiment 1: this comparative embodiment is the same as Embodiment 1, and the used base layer is seen in Table 2-1 and Table 2-2.

Comparative Embodiment 2: this embodiment is the same as Embodiment 1, and the used base layer is seen in Table 2-1 and Table 2-2.

I. Structure characterization: surface and end surface morphology characterization was performed on the membrane structures in embodiments and comparative embodiments described above. Specific data are as follows:

TABLE 1
Morphology structure of membrane section

| | | | | | | | Thickness | | |
|---|---|---|---|---|---|---|---|---|---|
| | | | | Support layer | | | of | | |
| | Thickness | Ultrafiltration | | | | Pore size | polytetra- | Thickness | Thickness |
| | of ultra- | layer | | | | change | fluoro- | of | of base |
| | filtration | Thick- | Fiber | Thick- | Fiber | gradient | ethylene | binding | material |
| Item | membrane/μm | ness/μm | diameter/μm | ness/μm | diameter/μm | nm/1 μm | layer/μm | layer/μm | layer/μm |
| Embodiment 1 | 232 | 0.2 | 26 | 37 | 34 | 46 | 35 | 35 | 160 |
| Embodiment 2 | 241 | 0.3 | 24 | 43 | 33 | 58 | 38 | 28 | 160 |
| Embodiment 3 | 208 | 0.2 | 28 | 5 | 37 | 24 | 43 | 12 | 160 |
| Embodiment 4 | 245 | 0.5 | 22 | 45 | 34 | 80 | 39 | 39 | 160 |
| Embodiment 5 | 154 | 0.6 | 24 | 23 | 33 | 76 | 130 | 35 | / |
| Embodiment 6 | 229 | 0.6 | 33 | 33 | 38 | 54 | 35 | 30 | 160 |
| Embodiment 7 | 215 | 0.8 | 35 | 35 | 41 | 59 | 179 | 25 | / |
| Embodiment 8 | 233 | 0.9 | 37 | 37 | 43 | 59 | 35 | 28 | 160 |
| Embodiment 9 | 228 | 1.2 | 39 | 32 | 49 | 69 | 35 | 25 | 160 |
| Embodiment 10 | 194 | 0.7 | 39 | 18 | 55 | 79 | 15 | 15 | 160 |
| Embodiment 11 | 228 | 0.9 | 45 | 32 | 58 | 70 | 35 | 20 | 160 |
| Embodiment 12 | 236 | 1.7 | 48 | 39 | 62 | 125 | 35 | 35 | 160 |
| Embodiment 13 | 322 | 1.9 | 47 | 12 | 70 | 77 | 58 | 44 | 250 |
| Embodiment 14 | 249 | 2.3 | 46 | 37 | 74 | 43 | 210 | 53 | / |
| Embodiment 15 | 339 | 3.3 | 54 | 49 | 78 | 178 | 17 | 17 | 270 |
| Embodiment 16 | 345 | 4.5 | 58 | 42 | 77 | 258 | 28 | 28 | 270 |
| Comparative | 254 | 0.4 | 29 | 59 | 35 | 138 | 35 | / | 160 |
| Embodiment 1 | | | | | | | | | |
| Comparative | 253 | 0.2 | 32 | 63 | 46 | 148 | 30 | / | 160 |
| Embodiment 2 | | | | | | | | | |

TABLE 2-1
Structure of base layer (polytetrafluoroethylene layer)

| | | | | | Node | | | Fiber filament | | | |
|---|---|---|---|---|---|---|---|---|---|---|---|
| | PMI | | | Water | | | Width | | | Width | Density/ |
| | pore | | Rough- | contact | | Average | differ- | | Average | differ- | fiber |
| Item | size/μm | Porosity/% | ness/μm | angle/° | S1/% | width/μm | ence/μm | S2/% | width/μm | ence/μm | filaments |
| Embodiment 1 | 5 | 75 | 1.2 | 54 | 25 | 3.7 | 3.4 | 12 | 0.58 | 0.7 | 30 |
| Embodiment 2 | 5 | 68 | 1.6 | 74 | 35 | 2.5 | 4.5 | 15 | 0.73 | 0.5 | 26 |
| Embodiment 3 | 5 | 60 | 2 | 66 | 45 | 3.4 | 5.1 | 4 | 0.33 | 1.1 | 15 |
| Embodiment 4 | 5 | 88 | 0.4 | 52 | 7 | 3.8 | 3.2 | 33 | 0.74 | 1.4 | 55 |
| Embodiment 5 | 5 | 75 | 0.5 | 64 | 24 | 3.2 | 3.5 | 14 | 0.48 | 0.7 | 33 |
| Embodiment 6 | 5 | 75 | 1.2 | 54 | 25 | 3.7 | 3.4 | 12 | 0.58 | 0.7 | 30 |
| Embodiment 7 | 5 | 73 | 1.1 | 55 | 28 | 3.8 | 2.9 | 14 | 0.77 | 0.9 | 35 |
| Embodiment 8 | 5 | 75 | 1.2 | 54 | 25 | 3.7 | 3.4 | 12 | 0.58 | 0.7 | 30 |
| Embodiment 9 | 5 | 75 | 1.2 | 54 | 25 | 3.7 | 3.4 | 12 | 0.58 | 0.7 | 30 |
| Embodiment 10 | 3 | 80 | 1.7 | 58 | 16 | 3.1 | 6.9 | 19 | 0.45 | 0.9 | 35 |
| Embodiment 11 | 5 | 75 | 1.2 | 54 | 25 | 3.7 | 3.4 | 12 | 0.58 | 0.7 | 30 |
| Embodiment 12 | 5 | 75 | 1.2 | 54 | 25 | 3.7 | 3.4 | 12 | 0.58 | 0.7 | 30 |
| Embodiment 13 | 3 | 79 | 1.7 | 50 | 15 | 4.1 | 3.8 | 15 | 0.53 | 0.6 | 33 |
| Embodiment 14 | 3 | 77 | 1.2 | 53 | 24 | 4.3 | 5.6 | 18 | 0.5 | 1.4 | 46 |
| Embodiment 15 | 0.8 | 87 | 1.8 | 53 | 18 | 4.4 | 3.9 | 15 | 0.5 | 1.2 | 38 |
| Embodiment 16 | 0.8 | 87 | 1.8 | 53 | 18 | 4.4 | 3.9 | 15 | 0.5 | 1.2 | 38 |
| Comparative | 5 | 75 | 1.2 | 104 | 25 | 3.7 | 3.4 | 12 | 0.58 | 0.7 | 30 |
| Embodiment 1 | | | | | | | | | | | |
| Comparative | 0.2 | 64 | 0.8 | 59 | 20 | 3.5 | 4.9 | 24 | 0.53 | 1.2 | 45 |
| Embodiment 2 | | | | | | | | | | | |

TABLE 2-2
Structure of base layer (non-woven fabric)

| | Air | Fiber | Gram |
|---|---|---|---|
| Item | permeability/cc/cm²/sec | thickness/μm | weight/g/m² |
| Embodiment 1 | 120 | 14 | 31 |
| Embodiment 2 | 120 | 14 | 31 |
| Embodiment 3 | 120 | 14 | 31 |
| Embodiment 4 | 120 | 14 | 31 |
| Embodiment 5 | / | / | / |
| Embodiment 6 | 120 | 14 | 31 |
| Embodiment 7 | / | / | / |
| Embodiment 8 | 120 | 14 | 31 |
| Embodiment 9 | 120 | 14 | 31 |
| Embodiment 10 | 120 | 14 | 31 |
| Embodiment 11 | 120 | 14 | 31 |
| Embodiment 12 | 120 | 14 | 31 |
| Embodiment 13 | 160 | 19 | 27 |
| Embodiment 14 | / | / | / |
| Embodiment 15 | 180 | 26 | 34 |
| Embodiment 16 | 180 | 26 | 34 |
| Comparative | 120 | 14 | 31 |
| Embodiment 1 | | | |
| Comparative | 120 | 14 | 31 |
| Embodiment 2 | | | |

TABLE 3
Structure of membrane surface

| | | Discrete | | | | | |
|---|---|---|---|---|---|---|---|
| | | coefficient | | | | | |
| | SEM | of SEM | | Water | | Water | |
| | average | average | Pore | contact | | contact | Wetting |
| | pore size | pore size | area rate | angle of | Roughness | angle of | time of |
| | of first side | of first side | of first side | first side | of first side | second side | entire |
| Item | surface | surface | surface/% | surface/° | surface/μm | surface/° | membrane |
| Embodiment 1 | 7 | 0.28 | 3.1 | 43 | 0.3 | 66 | <5 s |
| Embodiment 2 | 9 | 0.31 | 2.8 | 47 | 1.4 | 54 | <5 s |
| Embodiment 3 | 10 | 0.22 | 3.3 | 39 | 1.9 | 78 | <5 s |
| Embodiment 4 | 8 | 0.27 | 3.5 | 45 | 0.2 | 88 | <5 s |
| Embodiment 5 | 8 | 0.24 | 3.8 | 48 | 0.7 | 44 | <5 s |
| Embodiment 6 | 15 | 0.28 | 3.8 | 37 | 0.5 | 60 | <5 s |
| Embodiment 7 | 18 | 0.33 | 4.1 | 39 | 0.6 | 79 | <5 s |
| Embodiment 8 | 17 | 0.29 | 4.2 | 30 | 0.7 | 64 | <5 s |
| Embodiment 9 | 22 | 0.34 | 4.7 | 30 | 0.9 | 56 | <5 s |
| Embodiment 10 | 25 | 0.33 | 5.1 | 31 | 0.7 | 33 | <5 s |
| Embodiment 11 | 26 | 0.28 | 5.5 | 27 | 0.8 | 48 | <5 s |
| Embodiment 12 | 28 | 0.32 | 6.3 | 25 | 1.5 | 59 | <5 s |
| Embodiment 13 | 29 | 0.18 | 6.5 | 25 | 1.8 | 64 | <5 s |
| Embodiment 14 | 35 | 0.19 | 6.7 | 25 | 1.9 | 33 | <5 s |
| Embodiment 15 | 55 | 0.17 | 7.6 | 28 | 2.0 | 58 | <5 s |
| Embodiment 16 | 78 | 0.23 | 9.4 | 17 | 2.2 | 54 | <5 s |
| Comparative | 8 | 0.53 | 2.1 | 48 | 0.4 | 67 | >5 s |
| Embodiment 1 | | | | | | | |
| Comparative | 9 | 0.55 | 3.3 | 44 | 0.5 | 59 | <5 s |
| Embodiment 2 | | | | | | | |

It can be seen from the above table that the cellulose ultrafiltration membranes prepared in embodiments have relatively good membrane structures, the cellulose polymer layers in the prepared ultrafiltration membranes have relatively small defects, and therefore the ultrafiltration membranes have relatively good integrity; meanwhile the cellulose polymer permeates into the polytetrafluoroethylene layer to form the binding layer, thereby eliminating the phenomenon of solute accumulation so that the prepared ultrafiltration membrane has good flux and composite performance, and preventing the phenomenon of peeling during the use; and finally the thickness regulation of the support layer is facilitated so that the support layer is relatively thinned, thereby increasing the flux.

### II. Performance Characteristic

1. Filtration precision testing: specific results are seen in Table below:

| | Molecular weight of | Interception |
|---|---|---|
| | intercepted substance | efficiency |
| Embodiment | 3K | Greater than 90% |
| 1 | | |
| Embodiment | 3K | Greater than 90% |
| 2 | | |
| Embodiment | 3K | Greater than 90% |
| 3 | | |
| Embodiment | 3K | Greater than 90% |
| 4 | | |
| Embodiment | 3K | Greater than 90% |
| 5 | | |
| Embodiment | 10K | Greater than 90% |
| 6 | | |
| Embodiment | 10K | Greater than 90% |
| 7 | | |
| Embodiment | 30K | Greater than 90% |
| 8 | | |
| Embodiment | 50K | Greater than 90% |
| 9 | | |
| Embodiment | 100K | Greater than 90% |
| 10 | | |
| Embodiment | 100K | Greater than 90% |
| 11 | | |
| Embodiment | 300K | Greater than 90% |
| 12 | | |
| Embodiment | 300K | Greater than 90% |
| 13 | | |
| Embodiment | 300K | Greater than 90% |
| 14 | | |
| Embodiment | 500K | Greater than 90% |
| 15 | | |
| Embodiment | 750K | Greater than 90% |
| 16 | | |
| Embodiment | 3K | Greater than 90% |
| 17 | | |
| Comparative | 3K | 88% |
| Embodiment | | |
| 1 | | |
| Comparative | 3K | 85% |
| Embodiment | | |
| 2 | | |

In the present disclosure, the cellulose composite ultrafiltration membranes prepared in embodiments 1-10 purify various biological molecules in a manner of tangential flow filtration; the molecular weight cut off of the cellulose composite ultrafiltration membranes are 3 K-750 K, and the interception efficiencies of the cellulose composite ultrafiltration membranes are all greater than 90%, so as to ensure that biological molecules with various molecular weights are efficiently intercepted.

2. Flux testing: at the temperature of 25° C., 50 ml of test solution deionized water passed through a filter membrane with a diameter of 47 mm, time was recorded and the flux was calculated; wherein, the pressures in embodiments 10-16 were 0.68 bar; the pressures in embodiments 1-9 and comparative embodiments 1-2 were 3.8 bar; specific results are seen in Table below.

| | Flux/ml/min/cm² |
|---|---|
| Embodiment 1 | 0.067 |
| Embodiment 2 | 0.056 |
| Embodiment 3 | 0.041 |
| Embodiment 4 | 0.076 |
| Embodiment 5 | 0.043 |
| Embodiment 6 | 0.59 |
| Embodiment 7 | 0.42 |
| Embodiment 8 | 1.35 |
| Embodiment 9 | 2.58 |
| Embodiment 10 | 3.9 |
| Embodiment 11 | 3.7 |
| Embodiment 12 | 5.2 |
| Embodiment 13 | 5.4 |
| Embodiment 14 | 4.7 |
| Embodiment 15 | 6.9 |
| Embodiment 16 | 7.2 |
| Comparative | 0.021 |
| Embodiment 1 | |
| Comparative | 0.013 |
| Embodiment 2 | |

In the present disclosure, flow rate testing was performed on each embodiment. This membrane has relatively high flux, i.e., relatively rapid flow rate, and therefore fluid containing biological molecules is rapidly filtered, with high economic benefits. Base layers with composite requirements were not used in comparative Embodiment 1 and comparative Embodiment 2, and therefore the flux is relatively low under the condition of the same molecular weight cut off.

3. Mechanical strength testing: tensile strength testing was performed on a wet membrane, the ultrafiltration membranes in embodiments 1-16 had the tensile strength of no less than 10 MPa, the elasticity modulus of greater than 200 MPa and relatively high mechanical properties, and had relatively high pressure resistance during the use; however, the tensile strength and elasticity modulus in Embodiment 17 were relatively low, which did not meet practical use requirements.

4. Protein yield testing (the testing was performed according to a protein yield test method used in ultraporous membrane and preparation method thereof from Chinese patent CN201010154974.7, or by using other methods): all the protein yields of the ultrafiltration membranes in embodiments were greater than 90%, with relatively high protein yield and economic benefits.

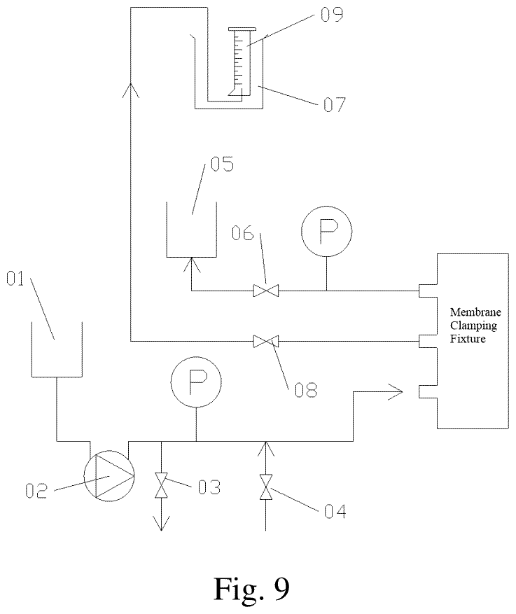

5. Diffusion flow testing: a 3 K membrane package of 0.11 m² was prepared by using the cellulose ultrafiltration membranes in embodiments 1-5 and then underwent diffusion flow testing. The specific method of diffusion flow testing is as follows: a membrane package with a filtration area of 0.11 m², as shown in FIG. 9, a testing device was assembled, a feed tank 01 was communicated with a liquid inlet hole at one side of the filtration membrane package through a liquid inlet pipeline, the liquid inlet pipeline was connected with a pump 02, a drain valve 03 and an air valve 04, a waste tank 05 was communicated with a liquid inlet hole at the other side of the filtration membrane package through a reflux pipeline, a reflux valve 06 was installed on the reflux pipeline, a breaker 07 was communicated with a filtrate hole of the filtration membrane package through a penetration pipeline, and a penetration valve 08 was installed on the penetration pipeline to open and close the on-off between the breaker 07 and the filtrate hole; and a 50 ml graduated cylinder 09 was filled with water and inverted in a 500 ml breaker 07 with water. During the testing, first, the air valve 04 was closed, a pressure adjuster was set as 0 bar (0 psi); second, the feed valve and the drain valve 03 were closed, the air valve 04, the reflux valve 06 and the penetration valve 08 were opened, water in membrane package feed-reflux pipeline was removed, and then the pressure adjuster was slowly adjusted to 0.35 bar (5 psi), so that air flew through the system, until the discharge of water from the reflux pipeline where the reflux valve was arranged was stopped; the reflux valve 06 was closed, so that water in the penetration pipeline was removed from the filtrate hole through an air pressure, and the pressure adjuster was slowly adjusted to 1 bar (15 psi); when a bubble rate was stable, corresponding time and an air volume in the graduated cylinder 09 were recorded; when 5-10 mL of air was collected, corresponding time and the air volume were recorded again; a diffusion flow was calculated (mL/min/@15 psi); results are seen in Table below.

| | Diffusion flow | | |
|---|---|---|---|
| | (mL/min@15 psi) | | |
| | 1 time | 3 time | 7 time |
| Embodiment | 1.4 | 1.8 | 2.1 |
| 1 | | | |
| Embodiment | 1.8 | 2.5 | 3.5 |
| 2 | | | |
| Embodiment | 4.7 | 6.8 | 9.4 |
| 3 | | | |
| Embodiment | 1.2 | 1.9 | 2.0 |
| 4 | | | |
| Embodiment | 5.8 | 7.4 | 10.4 |
| 5 | | | |

It can be seen from the above data that when a polytetrafluoroethylene layer with a node-cellulose structure defined within the scope of the present disclosure and a non-woven fabric base material layer are used as base layers, relatively better integrity was given to the membrane during the use, however, in Embodiment 3 and Embodiment 5, the diffusion flow is relatively large and the integrity is relatively poor, but they also meet a practical use standard (<12 mL/min@15 psi).

The above description describes preferred embodiments of the present disclosure in detail, however, it should be understood that those skilled in the art make various changes or modifications on the present disclosure after reading the above contents of the present disclosure. These equivalent forms are similarly included within the scope defined in claims appended by the present disclosure.

What is claimed is:

1. A cellulose ultrafiltration membrane, comprising a main body, wherein the main body comprises:
a first side surface supplying a liquid to be filtrated, and
a second side surface discharging a permeate liquor through the main body;
the main body being successively an ultrafiltration layer, a support layer and a base layer in a fluid flow direction;
wherein,
the ultrafiltration layer and the support layer each comprise a cellulose polymer layer, the base layer comprises a polytetrafluoroethylene layer, and
a PMI average pore size of the base layer is >0.8 μm;
the polytetrafluoroethylene layer is a hydrophilic polytetrafluoroethylene layer;
the cellulose polymer layer and the polytetrafluoroethylene layer permeate and bind to form a binding layer; and
a scanning electron microscope (SEM) average pore size of the first side surface is 1-90 nm.

2. The cellulose ultrafiltration membrane according to claim 1, wherein the discrete coefficient of the SEM average pore size of the first side surface is less than 0.5.

3. The cellulose ultrafiltration membrane according to claim 1, wherein the base layer comprises a base material layer that is arranged on the polytetrafluoroethylene layer and far away from the cellulose polymer layer, a surface of the base material layer far away from the polytetrafluoroethylene layer forms the second side surface, the base material layer comprises a non-woven fabric, and a thickness of the non-woven fabric is 30-85% that of the entire membrane, and the thickness of the non-woven fabric is 60-300 μm.

4. The cellulose ultrafiltration membrane according to claim 3, wherein the non-woven fabric has an air permeability of greater than 50 cc/cm²/sec, a fiber thickness of 5-30 μm, and a gram weight of 15-40 g/m².

5. The cellulose ultrafiltration membrane according to claim 3, wherein a thickness ratio of the cellulose polymer layer to the polytetrafluoroethylene layer is 0.1-3, a thickness of the cellulose polymer layer is 1-55 μm, and a thickness of the polytetrafluoroethylene layer is 15-90 μm.

6. The cellulose ultrafiltration membrane according to claim 3, wherein a thickness of the binding layer is 10-100% that of the polytetrafluoroethylene layer, and the thickness of the binding layer is 10-100 μm.

7. The cellulose ultrafiltration membrane according to claim 1, wherein the base layer is the polytetrafluoroethylene layer, the thickness ratio of the cellulose polymer layer to the polytetrafluoroethylene layer is 0.02-1, the thickness of the cellulose polymer layer is 1.5-60 μm, and the thickness of the polytetrafluoroethylene layer is 100-300 μm.

8. The cellulose ultrafiltration membrane according to claim 1, wherein the polytetrafluoroethylene layer has a PMI average pore size of 1-20 μm and a porosity of 60-90%; the surface roughness of the polytetrafluoroethylene layer is 0.7-2 μm.

9. The cellulose ultrafiltration membrane according to claim 1, wherein a water contact angle of the polytetrafluoroethylene layer surface is <80°, and a water contact angle of the second side surface is larger than that of the first side surface by no greater than 50°.

10. The cellulose ultrafiltration membrane according to claim 1, wherein a dry membrane is infiltrated into water to be wetted in 5 s.

11. The cellulose ultrafiltration membrane according to claim 1, wherein the roughness of the first side surface is 0.1-2.5 μm, the pore area rate of the first side surface is 1-10%, and the water contact angle of the first side surface is 10-55°.

12. The cellulose ultrafiltration membrane according to claim 1, wherein the ultrafiltration layer has an ultrafiltration fiber forming a porous structure, and the SEM average diameter of the ultrafiltration fiber is 20-60 nm;
the support layer has a support fiber forming a porous structure, and the SEM average diameter of the support fiber is 20-85 nm; and
an SEM average diameter ratio of the support fiber to the ultrafiltration fiber is 1.2-2.4.

13. The cellulose ultrafiltration membrane according to claim 1, wherein the thickness of the ultrafiltration layer is 0.1-5 μm, the thickness of the support layer is 0.5-50 μm, and a thickness ratio of the support layer to the ultrafiltration layer is 2-13.

14. The cellulose ultrafiltration membrane according to claim 1, wherein the average pore size of the support layer gradually increases in a fluid flow direction, and a change gradient is 20-450 nm/1 μm.

15. The cellulose ultrafiltration membrane according to claim 1, wherein
the thickness of the ultrafiltration membrane is 130-420 μm;
the standard molecular weight cut off of the ultrafiltration membrane is 1 K-750 K;
the tensile strength of the ultrafiltration membrane is no less than 10 MPa; and
a water flux of a 100 K cellulose ultrafiltration membrane is 1-1.8 mL/min/cm² under the conditions that a pressure is 0.68 bar and a temperature is 25° C.

16. The cellulose ultrafiltration membrane according to claim 1, wherein the polytetrafluoroethylene layer is prepared by a stretching method, and the surface forming the binding layer is a polytetrafluoroethylene layer binding face which comprises nodes and fiber filaments, and the nodes are interconnected through the fiber filaments.

17. The cellulose ultrafiltration membrane according to claim 16, wherein an area of the nodes occupying the surface of the polytetrafluoroethylene layer is S1;
an area of the fiber filaments occupying the surface of the polytetrafluoroethylene layer is S2;
the S1:S2 is 0.13-7; and
the area S1 of the nodes occupying the surface of the binding face is 4-40%; and the area S2 of the fiber filaments occupying the surface of the binding face is 5-35%.

18. The cellulose ultrafiltration membrane according to claim 16, wherein the average width of the node is 1-6 μm, and a difference between the largest width and the smallest width of the node is <7 μm; the average width of the fiber filament is 0.1-1.2 μm, and a difference between the largest width and the smallest width of the fiber filament is <1.5 μm.

19. The cellulose ultrafiltration membrane according to claim 16, wherein the quantity of celluloses connected along a length of 50 μm in the direction of the node is 15-70.

20. The cellulose ultrafiltration membrane according to claim 1, wherein the material of the cellulose polymer layer comprises one or more of a regenerated cellulose and a cellulose ester.

21. A preparation method of the cellulose ultrafiltration membrane according to claim 1, wherein
S1: preparing a membrane-casting solution comprising the following substances in parts by weight:
10-30 parts of cellulose polymer, 40-60 parts of polar solvent and 20-40 parts of pore-forming agent;
S2: casting the membrane-casting solution onto a hydrophilic base to form a liquid membrane; the hydrophilic base being a polytetrafluoroethylene porous membrane; and
the water contact angle of the surface of the polytetrafluoroethylene porous membrane being less than 80°, and the PMI pore size of the polytetrafluoroethylene porous membrane being greater than 1 μm;
S3: performing phase separation and solidification, i.e., immersing the liquid membrane into a coagulating bath for phase separation and solidification to prepare a finished membrane; and
S4: placing the finished membrane into a sodium hydroxide aqueous solution for hydrolysis, and then washing after hydrolysis to form the cellulose ultrafiltration membrane.

22. The preparation method according to claim 21, wherein
the cellulose polymer is at least one of cellulose nitrate, cellulose acetate and a regenerated cellulose; and
the cellulose acetate is selected from one or more of cellulose diacetate, cellulose triacetate, cellulose nitrate, cellulose acetate butyrate and cellulose acetate propionate.

23. The preparation method of the cellulose ultrafiltration membrane according to claim 21, wherein
the polar solvent comprises at least one of acetone, dioxane, dimethylacetamide, N-methylpyrrolidone, acetic acid, propionic acid, butyric acid and valeric acid; and
the pore-forming agent comprises at least one of polyvinyl pyrrolidone, polyethylene glycol and polyvinyl alcohol.

24. The preparation method of the cellulose ultrafiltration membrane according to claim 21, wherein the viscosity of the membrane-casting solution is 6000-40000 cpa·s.

25. The preparation method of the cellulose ultrafiltration membrane according to claim 21, wherein the lasting time of the phase separation and solidification is 5-60 s, the coagulating bath is water, and the phase separation temperature is 20-40° C.

26. The preparation method of the cellulose ultrafiltration membrane according to claim 21, wherein the concentration of the sodium hydroxide aqueous solution is 0.01 mol/L-1 mol/L; and the hydrolysis temperature is 30° C.-80° C., and the hydrolysis time is 40 min-200 min.

27. The preparation method of the cellulose ultrafiltration membrane according to claim 21, wherein the preparation of the cellulose ultrafiltration membrane comprises cross linking; and
the cross linking is that the cellulose ultrafiltration membrane is crosslinked with an aqueous cross linking agent for 20-400 min under an alkaline environment at the temperature of 30° C.-60° C.; and the cross linking agent is at least one of a halogenated epoxide, a double epoxide, a double halogenated alkane and a double halogenated alcohol.
